(19) United States
(12) Patent Application Publication
(10) Pub. No.: US 2011/0303100 A1
(43) Pub. Date: Dec. 15, 2011

(54) Conveyor Toaster with Air-Cooled Panels

(75) Inventors: Frank Agnello, South Elgin, IL (US); Loren Veltrop, Chicago, IL (US); Michael Soldwisch, Glen Ellyn, IL (US); Thomas Serena, Palatine, IL (US)

(73) Assignee: PRINCE CASTLE LLC, Carol Stream, IL (US)

(21) Appl. No.: 12/813,660

(22) Filed: Jun. 11, 2010

(51) Int. Cl. A47J 37/04; F28D 15/00

(52) U.S. Cl. 99/443 C; 99/324; 392/418; 165/104.19

(57) ABSTRACT

A conveyorized toaster oven for cooking flat breads, pita and the like uses infrared energy, which raises interior temperatures of the oven. A metallic shell is formed around the oven, which defines an air duct. A blower is configured to force air through the duct to remove heat energy from the exterior surface of the oven cabinet.

### BACKGROUND

Changing tastes as well as product differentiation has created a demand for certain foods that require baking at high temperatures for relatively short periods of time. Examples of these types of foods include flat breads and pita breads. A problem with high temperature ovens that can cook flat bread and pita bread is that their high temperatures require the oven walls to be heavily insulated in order to reduce burn risk. Even with insulation, conveyor-type ovens, which have interior temperatures of 900 degrees Fahrenheit or more have exterior surface temperatures hot enough to burn human skin. A cooking apparatus that is compact enough to be used on a countertop and which has a reduced exterior surface temperature would be an improvement over the prior art.

### BRIEF DESCRIPTION OF THE DRAWINGS

FIG. 1 is a perspective view of a conveyor toaster oven;

FIG. 2 is a perspective view of the conveyor toaster viewed from below the right side;

FIG. 3 is a cross sectional view of the conveyor toaster oven;

FIG. 4 is a cut a way view of the conveyor toaster oven;

FIG. 5 is another cutaway view of the conveyor toaster oven;

FIG. 6 is a partial exploded view;

FIG. 7 is another cross sectional view of the oven; and

FIG. 8, FIG. 9 and FIG. 10 are schematic depictions of conveyor toaster ovens.

### DETAILED DESCRIPTION

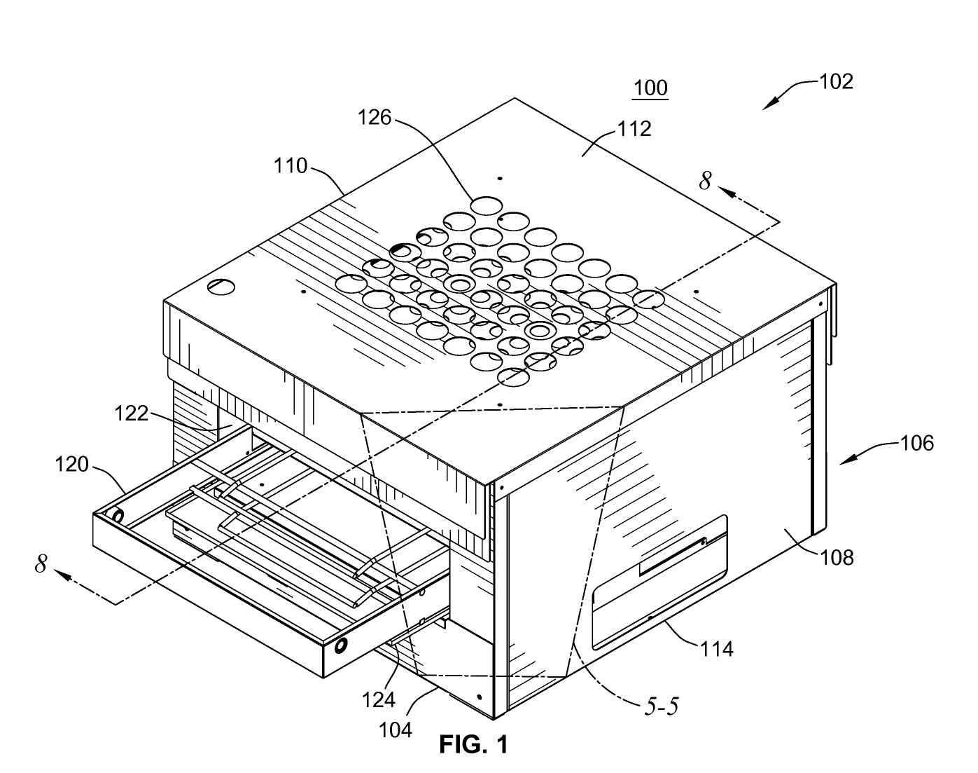

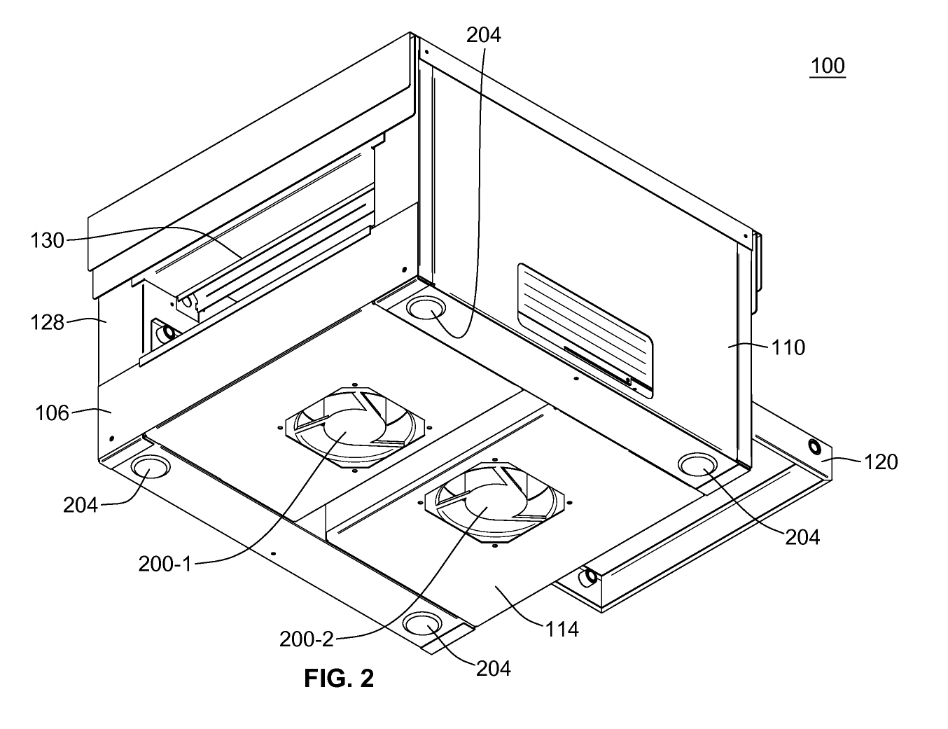

FIG. 1 is a perspective view of a conveyor toaster oven 100. The oven 100 uses infrared energy that is emitted from several electrically-resistive heating elements, not visible in FIG. 1, cook bread products like pizza and flat bread that are passed through the oven 100 on a metal conveyor 120. Foods are placed onto the end of the conveyor 120 that extends outward from an opening 122 in the left side 104 of the cabinet as shown in FIG. 1. Foods on the conveyor 120 pass through the oven 100, between infrared energy sources and exit the oven from the opposite side 106.

In order to cook flat bread, pita bread and pizza, the oven's interior temperatures are quite high, i.e., at or above about 900 degrees Fahrenheit. Exterior surfaces of the oven are kept below a temperature at which human skin will burn, i.e., about 140 degrees Fahrenheit, by a unique air cooling system that cools exterior panels using circulating room air.

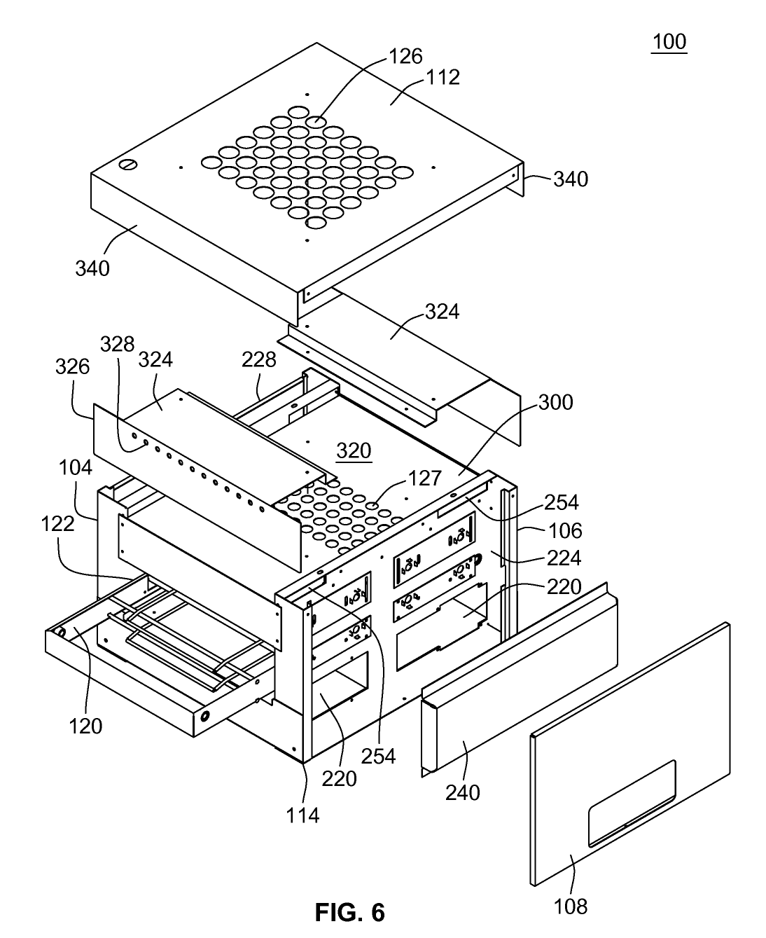

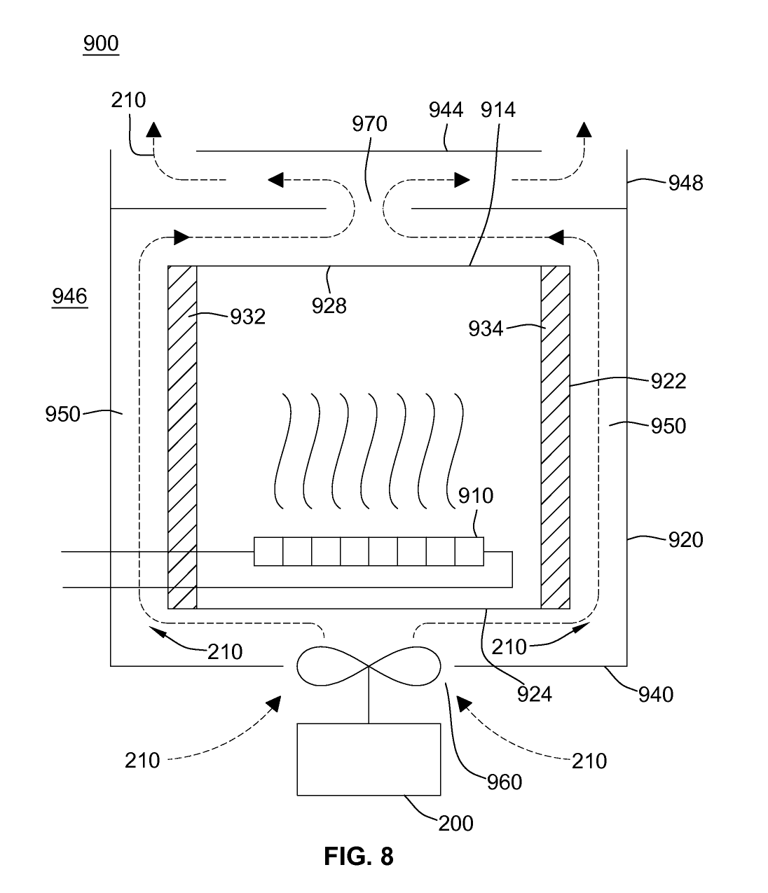

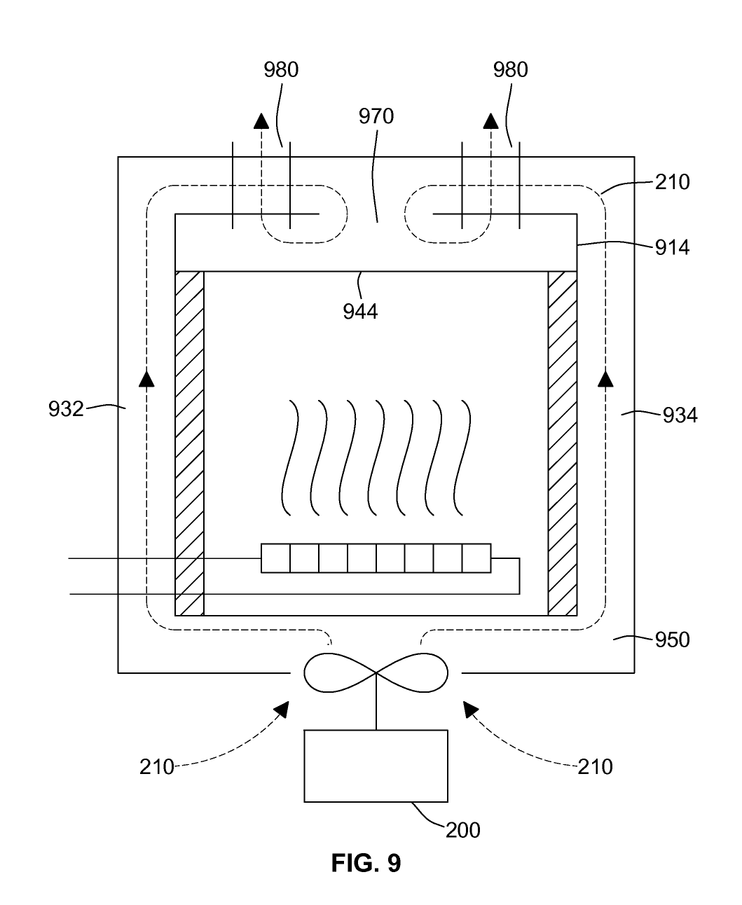

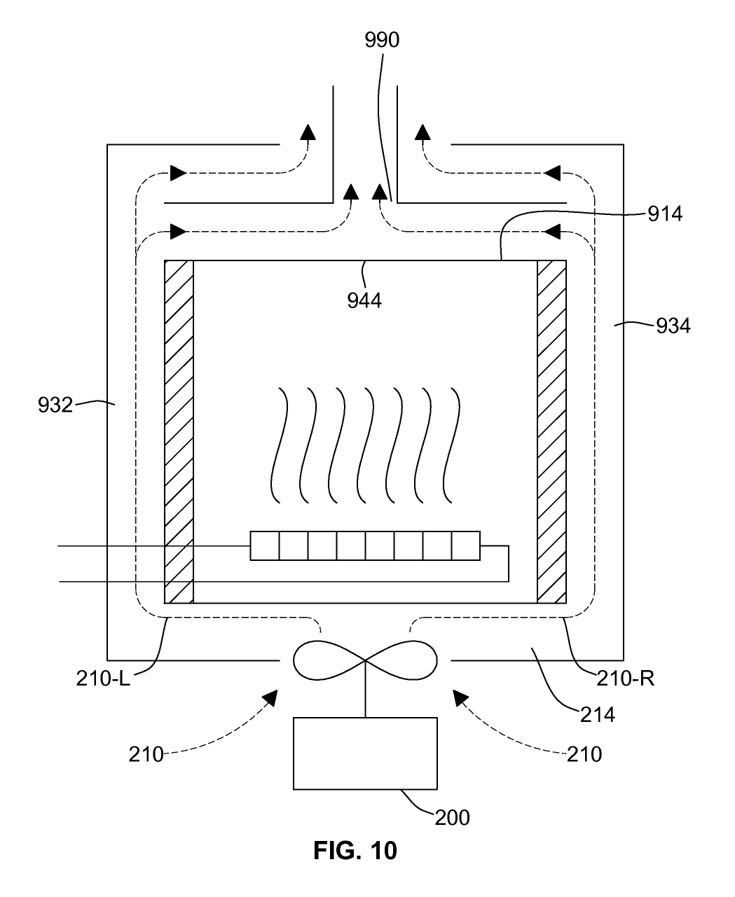

The oven, which is referred to herein as a cooking apparatus 100, is comprised of a parallelepiped-shaped shell structure 102 which envelopes or covers a parallelepiped-shaped oven cabinet, not visible in FIG. 1. As shown in FIG. 6 and FIG. 8, the oven cabinet 300 and shell structure 102 share a left side panel 104 and a right side panel. The right side panel 106 is best seen in FIG. 2. The shell structure 102 includes a front panel 108, an opposing rear panel 110, a top panel 112 and a bottom panel 114.

Part of a metal conveyor 120 extends from a rectangular opening 122 in the left side panel 104. Foods to be cooked are placed onto the portion of the conveyor 120 that extends from the opening 122 in the left side panel 104. The conveyor's rotation carries food items on the conveyor through the first opening 122 and into the oven cabinet 300. Inside the cabinet 300, foods on the conveyor 120 pass by infrared-emitted heaters mounted above and below the conveyor and which irradiate the top and bottom of the food items with high intensity infrared energy. The conveyor 120 drops food items out of a second opening 128 in the right side panel 106.

The conveyor 120 is comprised of a metal mesh belt, which rotates around mating metal sprockets. An adjustable combination food-crumb-collector/IR-heat shield 124 extends outwardly from the left end 104 from the opening 102 and under the portion of the conveyor 120 that extends from the first opening 122. The shield 124 is not fixed in place but is instead adjustable such that the distance that it extends from the first opening 122 can be changed simply by sliding the shield inwardly or outwardly from the first opening 122. The adjustable shield 124 collects food particles that drop from food items on the conveyor 120 but more importantly, the heat shield 124 intercepts IR that is emitted from heaters inside the oven 300 that would otherwise heat surfaces outside the oven 100. It also intercepts IR emitted from the first opening 122 that can “seen.”

In the preferred embodiment, the shell structure 102 partially covers the parallelepiped-shaped oven cabinet 300. The shell structure 102 is comprised of a stainless steel top panel 112 that extends over/covers a top panel 320 of the oven cabinet 300. A stainless steel front side panel 108 and a stainless steel rear side panel 110 cover a corresponding front side wall 224 and a rear side wall 228 of the oven cabinet 300.

The shell structure panels 108, 110 and 112 are configured to stand off from, i.e., be held away from, oven cabinet surfaces by a relatively small separation distance. The separation distance between the off-standing shell structure panels and the exterior surfaces of the oven cabinet 300 define air ducts that carry air over the oven cabinet exterior surfaces removing heat from the oven cabinet surfaces, which would otherwise be hot enough to severely burn human skin. Additional duct layers and air diverters described below direct air through the shell structure such that when the temperature inside the oven cabinet is as high as nine hundred degrees Fahrenheit, exterior surfaces of the conveyor toaster 100 are at or below a temperature at which human skin will burn, i.e., below about one-hundred forty degrees Fahrenheit.

In the preferred embodiment, the stand off distance of the shell structure panels from the oven cabinet surfaces is between about one-half inch and about one inch. Alternate spacings are used in alternate embodiments but in any case, the spacing, which corresponds to the air duct height, is great enough to carry a volume of air sufficient to keep exterior surfaces of the oven 100 below a temperature at which human skin will burn.

Still referring to FIG. 1, the top panel 112 is provided with several holes 126, each of them about one inch in diameter. The holes 126 in the top panel 112 comprise a terminal end of part of the air ducts defined by the shell structure panels and exterior surfaces of the oven cabinet 300 that is inside the shell structure 102. Fans not visible in FIG. 1 are located at the opposite or input end of the ducts and force room air through the duct structure, which carries room air over exterior surfaces of the oven cabinet 300 and out of the holes 126 in the top panel 112. The air forced through the duct structure formed by the shell structure 102 and oven cabinet 300 ventilates and cools the conveyor toaster oven 100.

FIG. 2 is a perspective view of the conveyor toaster oven 100 viewed from below the right side 106 of the toaster oven 100. The right side 106 of the oven toaster cabinet 100 has a rectangular opening 128 similar in size and shape to the left side opening 122. Both openings are configured to provide access to the interior of the oven cabinet 300. Both of them are thus configured to enable a food item to be placed onto and taken off of the conveyor 120.

Infrared energy is provided to the oven interior by several elongated, rod-shaped and electrically-resistive heating elements 133. When an electric current flows through the heating elements 133, they emit IR, as known in the art. The heating elements 133 are attached to the interior surfaces of the oven cabinet 300 above and below the conveyor. They are configured to emit IR toward the conveyor 120 from above and below the conveyor 120.

IR heating elements 133 are preferably used with infrared reflectors 130. In the preferred embodiment, the IR reflectors 130 have a shape reminiscent of a rain gutter and have a substantially U-shaped cross section. The IR reflectors 130 capture at least some of the IR that is emitted away from the conveyor by the heating elements 133 and, re-direct the IR back toward the conveyor 120. One of the gutter-shaped reflectors 130 can be seen in FIG. 2, just inside the right side opening 128, facing downward and toward the conveyor 120. An identical reflector 130 exists on the opposite left side 104 of the oven 100 but is not visible in FIG. 2.

The infrared reflectors 130 behind and in proximity to the heating elements 133 increase the amount of infrared energy that is directed to a food product from the infrared heaters. However, those of ordinary skill in the art will recognize that at least some of the infrared energy emitted from infrared heating elements 133 inside the oven cabinet 300 will exit through the openings on both ends of the oven toaster cabinet 100. While the aforementioned radiation shield 124 (on the left side 104) intercepts infrared energy emitted from the left-side opening 122, IR from the oven cabinet 300 left side opening 122 will nevertheless heat surfaces that comprise the left side 104; IR emitted from the right side opening 128 on the right side 106 will heat surfaces on the right side 106 of the oven toaster 100.

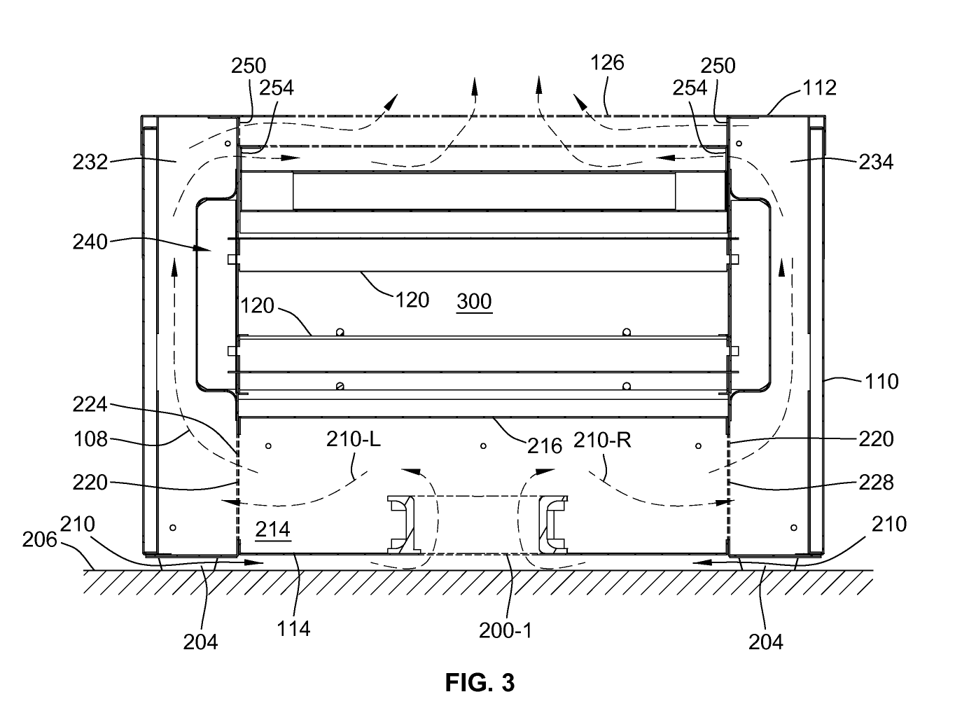

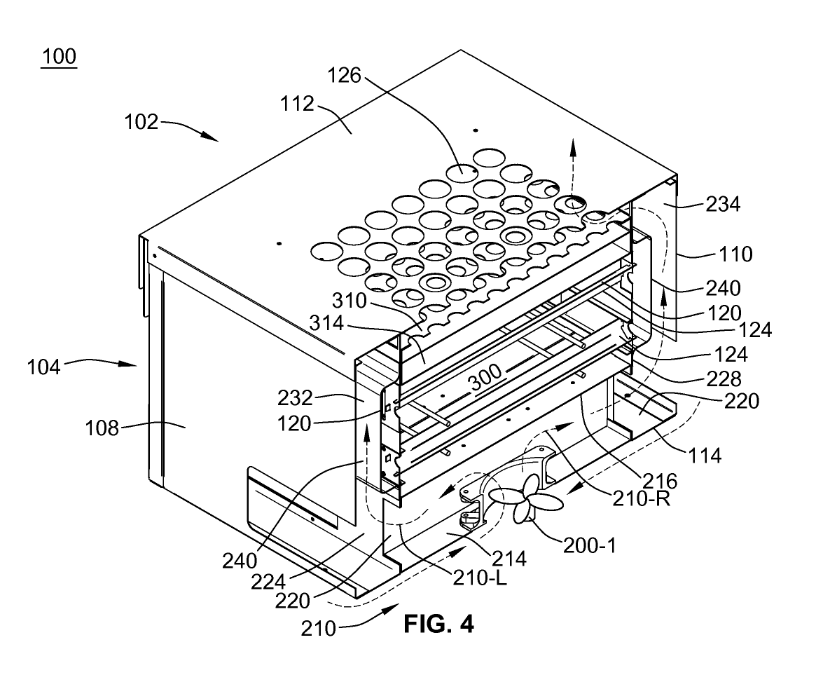

As mentioned above, exterior surfaces of the cooking apparatus 100 are cooled by forced air. In FIG. 2, two cooling fans 200-1 and 200-2 are mounted to the underside of the cooking apparatus 100. Exterior faces of the fans are flush with the bottom panel 114. As shown in FIG. 3, mounting feet 204 at each corner of the cabinet 100 keep the bottom panel 114 of the cooking apparatus 100 above the surface on which the cabinet 100 is operated to provide an air gap through which room air 210 can flow into the cooling fans 200. The cooling fans 200 force the air upwardly and into the duct aforementioned structure in order to provide cooling air to the surfaces of the aforementioned oven cabinet 300.

FIG. 3 is a cross sectional view of the conveyor toaster oven 100. The cross sectional view of FIG. 3 is one that is taken through the first cooling fan 200-1. Mounting feet 204 hold the conveyor toaster oven 100 above a countertop 206 and provide an air gap through which room air 210 flows under the conveyor toaster oven 100 and into the fan 200-1. Room air flow is identified by reference numeral 210.

Room air 210 that flows through the fan 200-1 enters a plenum chamber 214 formed by the bottom panel 114 of the shell structure, the bottom panel 216 of the oven cabinet 300 and the front and back side panels 108 and 110 respectively. Room air in the plenum 214 effectively splits into a left-side flow and right-side flow, which are identified by reference numerals 210-L and 210-R due to the fact that the air 210 flows out the left and right sides of the plenum 214. The left side flow 210-L is driven by the fan 200-1 through an opening 210 in the front side wall 224 of the oven cabinet 300. The right side flow 210-R is driven by the fan 200-1 through a similar opening 210 formed in the rear side wall 228 of the oven cabinet 300.

A front-side, plenum chamber/air duct identified by reference numeral 232 is formed by a combination of panels that include the front side wall 224 of the oven cabinet 300, the exterior front, bottom and top panels of the shell structure 102 as well as the left and right side panels 104 and 106. A substantial air flow is generated inside the plenum/duct 232 due to one or both of the fans 200-1 and 200-2 forcing room air into the plenum/duct 232. A similar rear plenum/air duct 234 is formed on the opposite side of the oven 100 by the rear panel 110 of the shell structure 102, the bottom panel 114 of the shell structure, the top panel of the shell structure 112, and the left and right ends 104 and 106 respectively. The right side air flow 210-R that flows through the opening 220 and the rear side wall of the oven cabinet 228 creates air flow at the back side plenum 234 as well. Air from the plenums 232 and 234 flows into two different ducts 310 and 314 above the top panel 320 of the oven cabinet 300. The plenums and ducts 310 and 320, which are formed by sheet metal panels that stand off from each other, are configured with the fans, to route air over oven cabinet surfaces in such a way that the surface temperatures of the cooking apparatus 100, are kept below a temperature at which human skin will burn, even while the interior temperature of the oven cabinet 300 is as high as nine-hundred degrees Fahrenheit.

FIG. 4 is a cut a way view of the conveyor toaster oven 100. The left and right forced air flows 210-L and 210-R from the first plenum 214 can be seen as coming out of the fan 200-1 and effectively splitting into two flows. The left and right flows 210-L and 210-R follow paths that are mirror images of each other. Since the two flows follow similar, mirror-image paths, the two flows preferably have equal speed and equal volumetric flow rate but it is not necessary, however, that the flow speeds be the same.

Referring now only to the first or left flow 210-L for brevity, the left-side flow 210-L goes toward the front panel 108 of the shell structure 102 and through an opening 220 in lower portion of the front side wall 224 of the oven cabinet 300. That air continues upwardly and around a thermally-insulated side cover 240 that covers electrical connections to the heating elements 133 that radiate IR inside the oven cabinet 300. An identical insulated side cover 240 covers the opposite rear side wall 262 of the oven cabinet 300. The side covers 240 are thermally insulated by a bed of fiberglass, not shown in the figures. Air that passes over the side covers 214 removes heat from their surfaces and continues upwardly toward the top or upper region of the respective plenums 232 and 234.

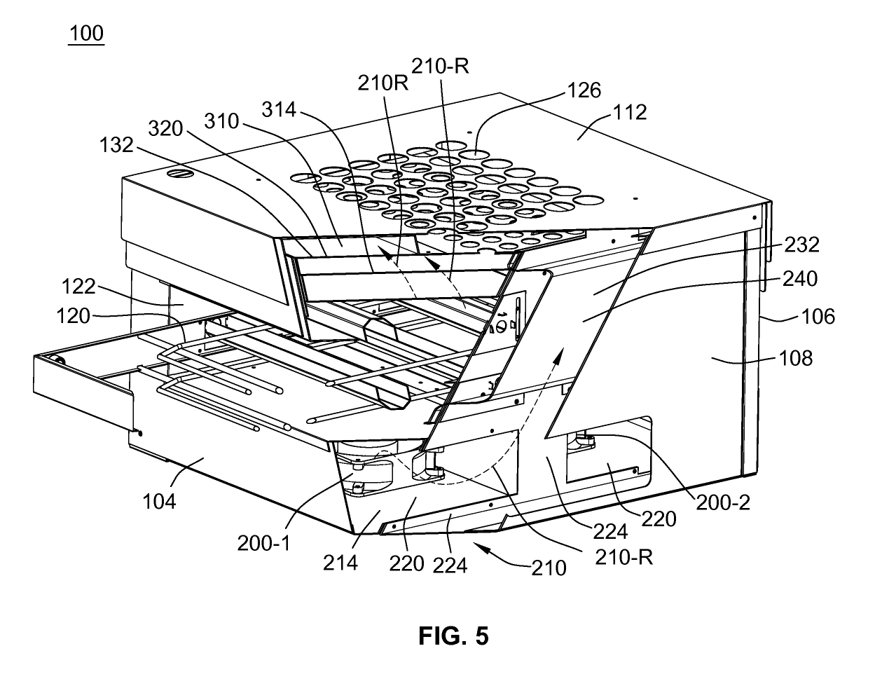

FIG. 5 is another cutaway view of the conveyor toaster 100 taken through the left-front corner of the conveyor oven 100 and through the left side of the front side plenum 232. A cooling fan 200-1 can be seen in the lower or bottom plenum 214. The ventilation holes 220 can be seen at the bottom of the left and right-hand sides of the front side wall 224 of the oven cabinet 300.

The aforementioned left-side air flow 210-L flows from the lower plenum 214, through the ventilation hole 220 and into the front side plenum 232. The forced air flow from the lower plenum flows through the front side plenum 232 (and the rear-side plenum 234). The left-side air flow 210-L is split into two separate flows as it passes out of the front side plenum 232 into two separate air ducts 310 and 314.

As best seen in FIG. 6, the lower air duct 314 is formed by a substantially L-shaped “duct forming/air directing panel” 324. The duct forming/air directing panel is affixed to the top panel 320 of the oven cabinet 300 and extends between the front side wall 224 of the oven cabinet 300 and the rear side wall 228 of the oven cabinet 300. Rectangular holes 254 are formed into the side walls 224 and 228 to admit air from the plenums into the lower air duct 314.

The top panel 320 of the oven cabinet 300 is provided with several holes 127 which extend through to the interior of the oven cabinet 300. Two, L-shaped duct forming/air directing panels 324 are attached to the top panel 320. They do not cover the holes 127 formed in the top panel 320 of the oven cabinet 300. The holes 127 formed in the top panel 320 are instead open to the ambient air through the holes 126 formed in the top panel 112 of the shell.

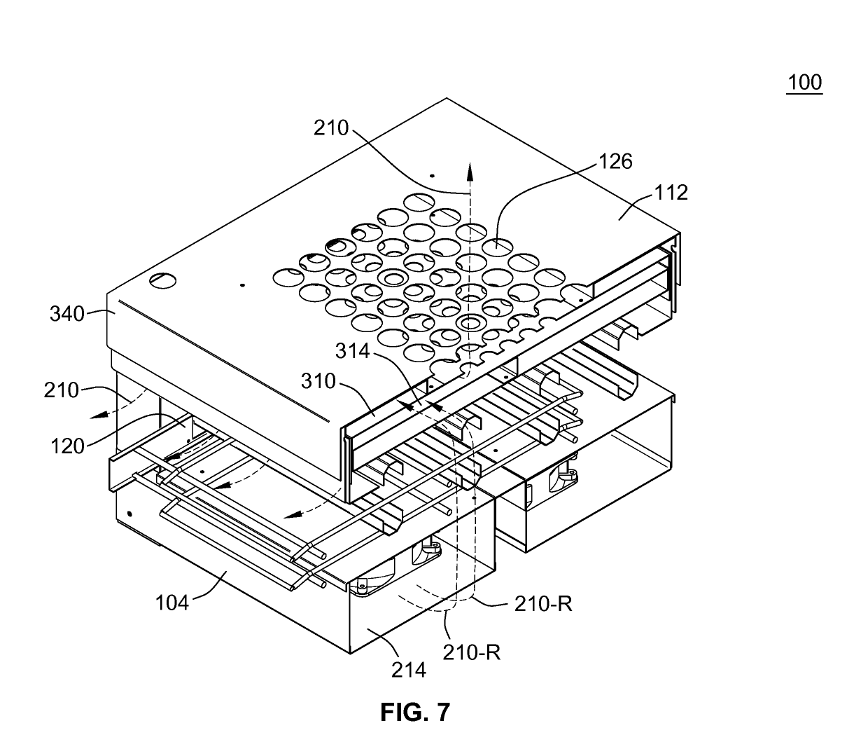

FIG. 6 and FIG. 7 show that upper air duct 310 is formed by a separation distance between the top panel 112 of the shell structure 102 and the top of the horizontal portion 325 of the duct forming/air directing panels 324. Air enters the upper air duct 310 through a rectangular hole 250, which is formed into the side walls 224 and 228 and located above the first rectangular hole 254 in order to admit air from the plenums into the upper air duct 310.

Together, FIGS. 4, 5, 6 and 7, show that air flowing into the lower duct 314 passes over the top surface panel 320 of the oven cabinet 300 and exits the conveyor oven toaster 100 through the exhaust holes 127 and 126. While the temperature of the air flowing out of the exhaust holes 127 and 126 might be quite high, it is not high enough to burn human skin.

FIG. 6 is considered a partial exploded view because it reveals the structure of the oven cabinet 300 and the structure of the shell 102, which is comprised of various panels that are spaced away from and which cover corresponding parts of the exterior surface of the oven cabinet 300.

The oven cabinet 300 is comprised of the aforementioned front side wall 224 and a rear side wall 228. The left side panel 104 having the aforementioned hole or opening is opposite a similarly-shaped right side wall 106 having a corresponding right side opening 128. The oven top panel 320 is opposed by the bottom panel 114. Several air holes 126 are also formed or punched into the top panel 320 as an exhaust for air 210 that flows into lower duct openings 254. Two panels 324 are formed to define the top duct 310 and the panels 324 are lowered into place over the top panel 320 of the oven cabinet. These top duct-forming panels 324 have a rectangular face 326 that is perforated with holes 328. The perforations or holes 328 extend into the top duct 310. Since the top duct 310 carries a forced air flow from the plenums 232 and 234 on either side of the oven cabinet 300, air is urged outwardly through the perforations 328.

Air that flows through the L-shaped duct-forming panels 324 impinges on an over-hanging panel 340 that is part of the top panel 112 of the shell 102. The over-hanging baffle 340 defines an air gap between the panel 340 and the perforations 328. It deflects air downwardly across the ends of the oven 100 and across the corresponding openings 122 and 124. Air that leaves the perforations 328 thus provides a cooling air stream to the ends of the oven.

FIG. 7 is another cross sectional view of the oven 100 taken just inside the front side wall 260 of the oven cabinet 300. Reference numeral 210-R shows the flow path of air exiting the plenum 214.

Some of the air flow 210-R enters the upper duct 310 while the remaining portion enters the lower duct 314. Air that flows into the lower duct 314 passes through the holes 126 formed in the top panel 320 of the oven cabinet 300. Air that flows into the top duct 310 passes through the aforementioned perforations and is directed downwardly by the baffle 340. Air streams identified by reference numeral 210 can be seen rolling downwardly and outwardly from the opening 120 in the left side 104 of the cabinet.

FIG. 8, FIG. 9 and FIG. 10 are schematic depictions of conveyor toaster ovens. The oven in FIG. 8 is comprised of an oven cabinet 914, the sides of which 932 and 934 are thermally insulated. The sides 932 and 934, top 928 and bottom 924 encloses an infrared heat source 910. Heat energy from the infrared heat source 910 applies heat to foods or food products inside the oven 914 to cook them. Heat that is radiated from the heat source 910 into the oven cabinet and re-radiated from the cabinet surfaces causes the exterior surface temperature to rise. A shell structure 920 is depicted as enveloping, i.e., enclosing the exterior surfaces 922 of the oven cabinet 914.

While there are only four sides shown in FIG. 8 because the figure shows the oven cabinet in cross section, the oven cabinet 914 in FIG. 8 is considered to be parallelepiped-shaped, i.e., having six sides adjacent ones of which are mutually orthogonal to each other. A top side 928 and bottom side 924 face each other as do the left and right sides 932 and 934. Not shown in FIG. 8 are the opposing left and right sides which lie in planes parallel to the plane of FIG. 8.

The shell structure 920 is comprised of a lower panel 940 that is attached to yet spaced away from the bottom surface 924 of the oven cabinet 914. An upper panel 944 forms a top surface of the conveyor toaster oven 900, below which are two duct layers on top of each other. A left panel 946 of the shell structure is attached to yet spaced away from the left side 932 of the oven cabinet 914 to define a left side duct 950. A right panel 948 of the shell structure is attached to yet spaced away from the right side 934 of the oven cabinet 914 to define a right side duct 950.

The space between the exterior surface 922 of the oven and the panels that define the shell structure form a duct or plenum with one on the left side and another on the right side, both of which are identified by reference numeral 950. Room air, which is identified by reference numeral 210, enters the duct 950 through a fan located at an inlet port 960 or first end of the duct, which is located below the oven cabinet 914.

Air driven by the fan flows upwardly over the insulated sides 932 and 934 and across the top panel 928 of the oven cabinet. The air flows through a passage or exit 970 that leads to a secondary duct 975 that is spaced above the top panel 928. By the time room air 210 reaches the exit port 970, it has passed over metallic surfaces of the oven cabinet 314 that heat the room air 210 to a high temperature. Air 210 leaving the exit port 970 thus heats the top surface 944, which makes the duct layout of FIG. 8 less than optimal due to the fact that air leaving the port 970 will be hot and will thereafter heat the top surface 944 of the shell structure 920.

FIG. 9 is a schematic depiction of an alternate embodiment of a conveyor toaster over. The oven has an air flow through the duct 950 that covers the bottom and sides of the oven cabinet 914 as with the oven in FIG. 8. In FIG. 9, however, air flows across the sides vertically and through a horizontal duct section adjacent to the ambient air then turns downwardly to flow over the much hotter top surface 944 of the oven cabinet 914. After the air flows over the top surface 944 of the oven cabinet, the air 210 is routed to exit ducts 980 located along opposing sides of the toaster oven.

In FIG. 8, relatively cool air flows across the very hot top surface of the oven cabinet 914 where the air picks up a lot of heat. The heated air then flows through a duct, the side of which is exposed to human skin.

In FIG. 9, relatively cool air flows vertically over the insulated sides before it flows horizontally to pass through a duct that is exposed to human skin. Since the air that flows through “upper” duct is relatively cool, surface temperatures of the top of the shell structure are relatively low. Relatively cool air from the upper duct is thereafter routed over the top surface of the very hot oven cabinet then discharged through an operator-safe exit port 980.

FIG. 10 schematically depicts the air flow used in the preferred embodiment of the oven, which is the flow used in the toaster oven depicted in FIGS. 1-7.

Room air 210 is forced by the fan 200 into the lower plenum 214. The air essentially splits into two substantially equal air flows 210-L and 210-R. The left and right air flows go vertically and pass over the thermally-insulated left and right sides 932 and 934 of the oven cabinet 914. At the top surface 944 of the oven cabinet, the left and right-side air flows split; one flow passes through a first duct, which is directly over the top surface 944 of the oven cabinet. A second flow passes through a second duct that is directly over the first duct.

Air that passes through the first duct and which directly contacts the top of the oven merges with air that passes through the higher, second duct. Both flows pass through an exhaust port formed of the several, large-diameter holes 126 in a top surface of the toaster oven that is itself protected by a cage, not shown in the figures. The exterior surfaces of the toaster oven are therefore cooled by forced air to reduce or eliminate the risk of burns.

Those of ordinary skill in the art will appreciate that the foregoing description is for purposes of illustrating operation of the invention recited in the appurtenant claims. The true scope of the invention is indeed defined by the claims.

What is claimed is:

1. A cooking apparatus comprising:
a metallic oven cabinet, having an interior where foods are cooked and having an exterior surface;
a heat source within the cabinet;
a metallic shell structure spaced away from and covering at least part of the exterior surface of part of the oven cabinet, the metallic shell structure and corresponding parts of the oven cabinet defining an air duct having a first end and a second end; and
at least one air blower configured to force air into the first end of the duct at the first end, over the exterior surface of the oven cabinet and toward the duct second end;
wherein air moving through the duct removes heat energy from the exterior surface of the oven cabinet.

2. The cooking apparatus of claim 1, wherein the shell structure has an exterior surface defining an exterior surface of the cooking apparatus.

3. The cooking apparatus of claim 2, wherein the heat source is configured to raise the interior region to a first temperature above which human skin burns, and wherein the duct, shell structure and blower are configured to maintain the exterior surface of the cooking apparatus at a second temperature, below which human skin burns.

4. The cooking apparatus of claim 2, wherein the oven cabinet has a shape reminiscent of a parallelepiped having first and second opposing ends, first and second opposing sides, a top and a bottom, the first end and the second end each having an opening through which the interior region can be accessed and through which food items can be passed.

5. The cooking apparatus of claim 4 further comprised of a conveyor extending between the first and second openings.

6. The cooking apparatus of claim 5, wherein the heat source is comprised of a plurality of infrared-emitting, electrically resistive heating elements, which direct infrared energy toward the conveyor.

7. The cooking apparatus of claim 6, further comprising an infrared reflector extending at least part way around the electrically resistive heating elements and directing infrared energy toward the conveyor.

8. The cooking apparatus of claim 4, wherein the shell structure forms a duct having first, second and third sections, the sections carrying air over the bottom, at least one side and at least part of the top surface of the oven cabinet respectively:
the first duct section having first and second ends, the first end configured to receive air from the at least one blower, the second end of the first duct section terminating at the second duct section;
the second duct section being comprised of a panel that is spaced away from, attached to and covering at least part of a side of the oven cabinet, the second duct section defining a plenum;
the third duct section being comprised of first and second duct layers, both of which are connected to the plenum, the first duct layer carrying a first air flow from the plenum that is in direct contact with the top side of the oven cabinet to an exhaust port, the second duct layer being above the first layer, thermally-insulating the first duct layer from the exterior surface of the cooking apparatus and carrying a second air flow over the first layer.

9. The cooking apparatus of claim 8, wherein the first and second layers vertically stacked with the second layer being above the first duct layer.

10. The cooking apparatus of claim 8, wherein the first end of the oven cabinet is comprised of:
a first air deflecting baffle operatively coupled to and receiving air from the second layer of the third duct portion, the first air deflecting baffle being configured to direct air from the third duct portion downwardly across the first opening.

11. The cooking apparatus of claim 10, wherein the first air deflecting baffle is comprised of:
a plurality of perforations in the first end of the oven cabinet that extend into the third duct portion; and
an air deflecting panel spaced away from the perforations by a first predetermined distance, which defines an exterior cooling air flow path, the air deflecting panel directing exterior cooling air downwardly across the first opening in the oven cabinet.

12. The cooking apparatus of claim 8, further comprised of a fan wherein the air deflecting panel is L-shaped.

13. The cooking apparatus of claim 12, further comprised of an L-shaped insulating section separated from the L-first air deflecting baffle by a second predetermined distance, the second predetermined distance defining an air gap between the air deflecting panel and the insulating panel.

14. The cooking apparatus of claim 13, wherein the plurality of infrared-emitting, electrically resistive heating elements are located above the conveyor.

15. The cooking apparatus of claim 10 further including a substantially planar infrared shield located below the first opening, above the bottom of the oven cabinet and extending away from the first end of the oven cabinet substantially horizontal, the infrared shield having a horizontal extension distance selected to prevent infrared from the heating element from impinging on surfaces at level that is below the infrared shield and which are spaced horizontally from the first end of the oven cabinet by about six inches or less.

16. The cooking apparatus of claim 15, wherein the infrared shield has a first planar side facing the plurality of infrared-emitting, electrically resistive heating elements and a second side having a heat sink thermally coupled thereto.

17. The cooking apparatus of claim 15, wherein the horizontal extension of the infrared shield is adjustable.

18. A method of cooling surfaces of a cooking apparatus, the cooking apparatus comprised of an oven cabinet wherein food is cooked and which has a first exterior surface, a conveyor that extends between first and second openings through which a food product can be passed and an infrared heat source within the oven cabinet and directing infrared heat energy toward the conveyor, the infrared heat source also acting to raise the temperature of the first exterior surface, the cooking apparatus also having a shell which covers at least part of the oven cabinet and which defines at least one air duct between the exterior surface of the oven cabinet and the shell, at least part of the shell also defining an exterior surface of the cooking apparatus, the method comprising the steps of:
forcing air through the duct to remove heat energy from the exterior surface of the oven cabinet and to reduce the exterior surface of the cooking apparatus below a temperature at which human skin will burn.

19. The method of claim 18 further comprising the step of directing at least some of the air flowing through the duct, across one of the first and second openings.

20. The method of claim 18, wherein the step of forcing air through the duct includes the step of forcing air through the duct using a blower, operatively coupled to the at least one air duct.
